(19) United States
(12) Patent Application Publication
(10) Pub. No.: US 2007/0039659 A1
(43) Pub. Date: Feb. 22, 2007

(54) Stabilization means for a corrugated hose and method for applying the stabilization means to a corrugated hose

(75) Inventors: Isa Coel, Frankfurt (DE); Werner Hempel, Nidderau (DE); Andreas Seyler, Gruendau (DE); Thomas Roesch, Linsengericht-Grossenhausen (DE)

Correspondence Address: BUCHANAN, INGERSOLL & ROONEY PC, POST OFFICE BOX 1404, ALEXANDRIA, VA, 22313-1404, US

(73) Assignee: VERITAS AG, Gelnhausen (DE)

(21) Appl. No.: 11/486,037

(22) Filed: Jul. 14, 2006

(30) Foreign Application Priority Data
Jul. 22, 2005 (DE) 10 2005 034 389.9

(51) Int. Cl. F16L 9/00

(52) U.S. Cl. 138/173; 138/172; 138/121

(57) ABSTRACT

The present invention relates to a stabilization means for a corrugated hose comprising at least one corrugated portion with at least one corrugation which projects relative to the corrugated hose and which extends, at least in certain sections thereof, essentially in the circumferential direction of said corrugated hose, said stabilization means comprising at least one annular segment which, when mounted on said corrugated hose, surrounds the circumference of said corrugated hose adjacent the corrugation. For improving the vibration behaviour of corrugated hoses, in particular of charge air hoses, the present invention is so conceived that a stabilization means is provided, in the case of which the annular segment is a substantially planar structure comprising individual threads or strands that are arranged relative to one another.

### CROSS-REFERENCE TO RELATED PATENT APPLICATION

This application claims the benefit under 35 U.S.C. §119 of German Patent Application No. 10 2005 034 389.9, filed on Jul. 22, 2005, the disclosure of which is incorporated herein in its entirety by reference.

### BACKGROUND

The present invention relates to a stabilization means for a corrugated hose comprising at least one corrugated portion with at least one corrugation which projects relative to the corrugated hose and which extends, at least in certain sections thereof, essentially in the circumferential direction of said corrugated hose, said stabilization means comprising at least one annular segment which, when mounted on said corrugated hose, surrounds the circumference of said corrugated hose adjacent the corrugation.

Such a stabilization means is known e.g. from German patent application 10 2004 038 087.2-24. In order to reduce the noise level caused by the vibrations of a corrugated hose, when said hose is used e.g. as a charge air hose, the corrugated hose according to said publication is stabilized by annular holding means, which are respectively arranged in the valleys between the waves. The annular holding means are additionally interconnected through connecting portions which extend between the respective holding portions such that they bridge the corrugations. Due to this mode of arrangement of the stabilization means, operation-dependent elongations in the longitudinal direction and in the transverse direction of the corrugated hose will be counteracted effectively, whereby the vibration tendency of the corrugated hose in its entirety will substantially be reduced. However, this solution cannot satisfy the increasing demands, e.g. with regard to weight optimization, flexibility and easier mounting, in all points.

### SUMMARY

A stabilization means is disclosed wherein a radial expansion and an elongation in the axial direction of a corrugated hose will be reduced, whereby the noise behaviour of a corrugated hose can be improved. Simultaneously, high flexibility, low weight and little mounting effort can be achieved by the stabilization means.

A stabilization means is disclosed wherein an annular segment is a substantially planar structure comprising individual threads or strands that are arranged relative to one another.

It turned out that the wear at the points of contact between the annular segment and the corrugated hose can be avoided to a very large extent by such an annular segment. In contrast to comparatively stiff annular segments consisting e.g. of solid plastic material, the annular segments, which are arranged in the valleys between the waves, can essentially adapt themselves to the contour of the valley. High surface pressures, which occur in the area of the contact point between the annular segment and the corrugated hose when stiff annular segments are used, are avoided in this way. Particularly high surface pressures occur in the case of stiff annular segments at locations where the corrugated hose is curved, a curved shape of the corrugated hose being necessary in view of the fact that the space available for installing the hose is normally narrow. This curved shape has the effect that the distance between two neighbouring corrugations will be reduced on one side of the corrugated hose, and the wave flanks will apply an additional force to the annular segment positioned between said neighbouring corrugations, whereby the surface pressure in the area of the edges of the annular segment will be increased once more. The high surface pressures described are problematic for the wear that occurs at the contact points between the annular segment and the corrugated hose. This wear is caused by minimum relative movements between the corrugated hose and the annular segment, said relative movements resulting from the vibrations which normally occur during operation. The relative movements described cause frictional loads at the points of contact, and these frictional loads cause wear. Experience has shown that higher losses of material occur at locations under high surface pressure. The wear can occur at the annular segment as well as at the corrugated hose. An increased amount of wear will finally lead to cracks in the corrugated hose or in the annular segment and, consequently, to a reduced functional capability of the corrugated hose and of the annular segment, respectively.

In addition, a corrugated hose provided with a stabilization means according to the present invention can be extremely flexible and it satisfies high demands with respect to mounting and vibration behaviour.

It may be of advantage when the annular segment has a knitted structure. This will result in a high flexibility of the annular segment in the longitudinal direction of the corrugated hose in combination with high strength and little expansion in the circumferential direction. Furthermore, the mechanical characteristics of the annular segment can effectively be influenced by the knitted structure with respect to the demanded stabilization and damping measures.

In addition, it may be of advantage when the annular segment has a woven or braided structure, whereby it will be possible to achieve a particularly high strength in the circumferential direction as well as sufficient flexibility in the longitudinal direction of the corrugated hose. Also in this case, the mechanical characteristics of the annular segment can effectively be influenced with regard to the demanded stabilization and damping measures.

It may prove to be advantageous when the threads or strands defining the annular segment consist of a natural material, preferably cotton or cellulose. These materials are very reasonable in price and extremely environment-friendly and they have good damping characteristics.

Furthermore, it may prove to be advantageous when the threads or strands defining the annular segment consist of a polymer material, preferably of polyester, polyamide, polypropylene, polyethylene or aramid. These materials have good mechanical characteristics and good frictional characteristics and, in addition, they are highly resistant to media which are normally present in the engine compartment. Furthermore, polymer materials have a high mechanical damping capability.

Furthermore, it may be of advantage when the threads or strands defining the annular segment consist of an inorganic, non-metallic material or of a metallic material. These materials have, in comparison with natural materials or polymer materials, higher strengths and, consequently, they will satisfy high demands with respect to the reduction of the radial expansion of the cross-sectional area of the corrugated hose.

It may prove to be advantageous when the annular segment is positively connected to the corrugated hose. This will reliably guarantee that the expansion of the corrugated hose is radially restricted by the annular segment, and the annular segment can less easily change its geometrical position.

Furthermore, it may be of advantage when the annular segment is connected to the corrugated hose by a substance-to-substance bond. The radial expansion of the cross-sectional area of the corrugated hose can thus be restricted more effectively, and a change of the geometrical position of the annular segment is excluded. In addition, the longitudinal expansion of the corrugated hose will be reduced to a certain extent by the substance-to-substance bond described.

In addition, it may be of advantage when the annular segment is connected to the corrugated hose in such a way that it is under tension in the circumferential direction. This can effectively prevent a radial expansion of the cross-sectional area, and a change of the geometrical position of the annular segment is largely prevented.

Furthermore, it may be of advantage when at least two annular segments are provided, and when at least one of the corrugations is adapted to be arranged therebetween, at least one connecting means being provided, which extends between the annular segments such that it bridges the at least one of said corrugations and which interconnects the annular segments. Due to the connecting means, the longitudinal expansion of the corrugated hose will be reduced drastically, whereby also the vibrations of the corrugated hose will be restricted still further. In spite of the connecting means, the corrugated hose provided therewith will remain flexible to a sufficient extent.

In accordance with another advantageous embodiment of the present invention, the connecting means is defined by a connecting portion which inter-connects the two annular segments, said connecting portion being fixedly connected to at least one of said annular segments. In this way, a connecting means can be realized, which has a modular structural design so that individual elements consisting of an annular segment and a connecting portion are adapted to be connected to a further element of the same kind, which also consists of an annular segment and of a connecting portion, so as to adapt the stabilization means to the length of the corrugated portion of the hose or to the number of corrugations in each individual case.

It may prove to be advantageous when the connecting portion is adapted to be releasably connected to at least one of said annular segments, whereby a modular structural design of the stabilization means will again be possible and mounting will be simplified at the same time.

It may be of advantage when the connecting portion consists of a natural material, preferably of cotton or cellulose. These materials are extremely reasonable in price and, simultaneously, they are very environment-friendly and they have good damping characteristics.

Furthermore, it may be of advantage when the connecting portion consists of a polymer material, preferably of polyester, polyamide, polypropylene, polyethylene or aramid. These materials have very good mechanical characteristics and very good frictional characteristics, and they are highly resistant to media which are normally present in the engine compartment. Furthermore, they are easy to process and they have very good damping properties.

In addition, it may be of advantage when the connecting portion consists of an inorganic, non-metallic material or of a metallic material. Such materials have, in comparison with natural materials or polymer materials, higher strengths and a lower expansibility.

It may also prove to be advantageous, when the connecting portion is integrally connected to at least one of said annular segments, the annular segment and the connecting portion consisting of the same material. Production and mounting can essentially be facilitated in this way.

In this respect, it may be of advantage when all the annular segments and connecting portions are integrally connected to one another, the annular segment and the connecting portion consisting of the same material. A particularly simple, low-priced an stable stabilization means can be realized in this way.

According to another advantageous further development of the present invention, the connecting portion can abut on the at least one corrugation at least in certain sections thereof, whereby the corrugated hose is encompassed in a cagelike manner. Due to the fact that the connecting portion abuts on the corrugation at least in certain sections thereof, the stabilizing effect will be improved.

Furthermore, it may prove to be advantageous when the connecting portions interconnecting the annular segments are arranged along a line, preferably in the longitudinal direction of the corrugated portion. The individual connecting portions can thus extend along the corrugated portion like a tape so as to efficiently limit the elongation in the longitudinal direction.

In addition, it may also prove to be advantageous when the connecting portions are essentially tape-shaped. This allows the production of a very light stabilization means that can be produced at a reasonable price. In addition, such a structural design allows a controlled limitation especially of the elongation in the longitudinal direction of the corrugated hose in combination with a bending flexibility of the hose.

Furthermore, it may here be of advantage, when the width of the connecting portions in the circumferential direction of the corrugated portion is substantially equal to or smaller than the distance between the two annular segments connected by the connecting portion. Also this will allow to realize a particularly light, but nevertheless efficient stabilization means.

In addition, it may prove to be advantageous when the width of the connecting portions corresponds essentially to half the distance between the two annular segments connected by the connecting portion. Also this will allow to realize a particularly efficient and light stabilization means, which is able to efficiently limit the longitudinal expansion of the corrugated hose and which simultaneously allows a high bending flexibility of the corrugated hose.

In order to control the longitudinal expansion of the corrugated hose even more effectively, it may prove to be advantageous when at least two spaced connecting portions are provided on the circumference of the annular segments.

In this respect, it may be of advantage when the circumferentially spaced connecting portions are arranged on opposed sides of the annular segments. On the one hand, this will allow a controlled limitation of the longitudinal expansion of the corrugated hose and, on the other hand, it will be possible to maintain an effective bending flexibility of the corrugated hose. The bending flexibility of the corrugated hose will especially be maintained in a direction in which the connecting portions are positioned essentially on the neutral line of the inflection.

It may also be of advantage when the connecting portions are displaced by 120° relative to one another in the circumferential direction of the annular segments. The strength of the stabilization means can be improved in this way.

According to an alternative embodiment, it may prove to be advantageous when the connecting portions are displaced by 90° relative to one another in the circumferential direction of the annular segments. Also this will allow an improvement of the strength of the stabilization means.

Furthermore, it may prove to be advantageous when connecting portions which define neighbouring connecting portions in the circumferential direction have different lengths. A predetermined curvature can be imparted to the corrugated hose in this way.

In addition, two neighbouring annular segments can define an angle so that the hose has a curvature. It is imaginable that the connecting portions are, in the first instance, essentially identical in length, but that, due to the curvature of the corrugated hose, the connecting portions on the inner side of the curvature droop, so to speak, whereas the connecting portions on the outer side of the curvature are under tension.

According to a further advantageous embodiment of the present invention, the connecting portions can extend at an oblique angle to the longitudinal direction of the hose. The flexibility of the corrugated hose can be increased in this way.

It my also be of advantage when the connecting portions intersect one another. The strength or the flexibility of the hose can effectively be influenced in this way.

The present invention additionally relates to a corrugated hose comprising at least one corrugated portion with at least one corrugation which projects relative to the corrugated hose and which extends, at least in certain sections thereof, in the circumferential direction of said corrugated hose, and further comprising a stabilization means according to one of the preceding claims.

Furthermore, the present invention relates to a corrugated hose comprising at least one corrugated portion with at least one bulge having a substantially semicircular contour, said bulge projecting relative to the corrugated hose and extending, at least in certain sections thereof, in the circumferential direction of said corrugated hose, and said bulge being followed on either side thereof by a corrugated hose portion having a substantially constant diameter, and further comprising a stabilization means according to one of the preceding claims.

In addition, the present invention relates to a method for applying the stabilization means described to the outer surface of a corrugated hose.

In this respect, it may be of advantage when the stabilization means is applied by knitting it continuously around the corrugated hose. This method can be applied in a simple and low-priced manner and it allows an effective adaptation of the structure and of the geometrical dimensions of the stabilization means to the respective loads acting on the corrugated hose.

In this connection, it may prove to be advantageous when automatic circular knitting machines are used for executing said continuous knitting, said knitting machines allowing an economic production with high production quality and a great variety of variation possibilities.

It may be of advantage when in the case of an elastomeric corrugated hose, the stabilization means is knitted onto the raw corrugated hose. A very simple and economic knitting-on can especially be achieved, when the hose is in the raw state and does not yet have any corrugations.

Furthermore, it may prove to be advantageous when a braiding method or a weaving method is used instead of the knitting method. On the basis of these various methods, a structure of the stabilization means can be chosen, which is the best possible structure for resisting the respective loads that act on the corrugated hose during operation.

In addition, it may be of advantage when the stabilization means is pulled over the corrugated hose. Very simple and fast mounting can be achieved in this way.

In this respect, it may be advantageous when the corrugated hose consists of an elastomeric material and when the stabilization means is pulled over the elastomeric corrugated hose in a pre-vulcanized or vulcanized condition, whereby advantageous handling will be guaranteed during the mounting operation.

### BRIEF DESCRIPTION OF THE DRAWINGS

In the following, the mode of operation of the present invention will be explained in detail:

FIG. 1 shows a first exemplary embodiment of the stabilization means according to the present invention with a corrugated hose;

FIG. 2 shows a stabilization means according to the present invention with a corrugated hose according to a second exemplary embodiment;

FIG. 3 shows a third exemplary embodiment of the stabilization means according to the present invention with a corrugated hose.

### DETAILED DESCRIPTION

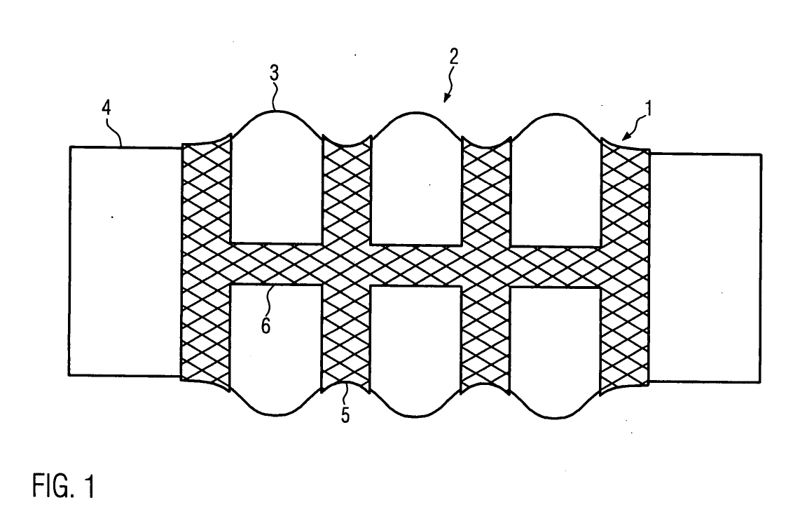

FIG. 1 shows an exemplary stabilization means 1 according to the present invention comprising a corrugated hose 2 in a side view.

The corrugated hose includes a flexible, elastomeric material and is substantially tubular. In the embodiment shown, the corrugated hose is straight and comprises a corrugated portion with three regularly spaced corrugations 3. It goes without saying that the hose may also comprise a higher or a smaller number of corrugations. Likewise, the corrugated hose may also be curved.

The corrugations extend substantially annularly in the circumferential direction of the corrugated hose, the largest diameter of the corrugations 3 being larger than the cylindrical outer surfaces 4 of the corrugated hose adjacent the corrugations 3. The corrugations may also vary in shape. It is, for example, imaginable to configure the corrugations such that, in the representation according to FIG. 1, their outer diameter becomes larger from one corrugation to the next from the left to the right. The outer peripheries of the corrugations will then be located substantially within a conical surface. Likewise, the outer diameters of the corrugations can decrease or increase from the outer corrugations to the inner corrugation.

The corrugated hose 2 is intended to be used as a so-called charge air hose in the field of automotive engineering.

The stabilization means 1 includes (e.g., consists of), for example, aramid. It can include a plurality of knitted annular segments 5 which are arranged parallel to one another and which are essentially tape-shaped. In the representation according to FIG. 1, said annular segments 5 encompass the corrugated hose, four annular segments 5 being provided and the two inner annular segments being arranged in the valleys between two neighbouring corrugations. The circumferential lengths of the annular segments shown are essentially identical in the mounted condition. The size and the shape of the annular segments can, of course, be adapted to the number of corrugations. Likewise, it is imaginable that two or more corrugations are provided between two annular segments.

The annular segments are integrally connected to one another by connecting portions 6 and said connecting portions are knitted onto said annular segments. These connecting portions 6 extend between respective neighbouring annular segments and they are adapted to the profile of the corrugations. The connecting portions 6 extend essentially in the longitudinal direction of the corrugated portion of the corrugated hose. They are essentially tape-shaped, their width in the circumferential direction of the corrugated hose corresponding essentially to the width of the annular segments 5 in the longitudinal direction of the corrugated hose.

Two respective connecting portions 6 connect two neighbouring annular segments 5. The two connecting portions 6 are displaced by 180° in the circumferential direction (the connecting portions that are displaced by 180° relative to the depicted connecting portions cannot be seen in FIG. 1). Alternatively, also a plurality of connecting portions 6 may be distributed over the circumference. It would be imaginable to provide e.g. three connecting portions which are arranged such that they are displaced by 120° relative to one another. Likewise, it is also possible to provide four connecting portions 6 that are displaced by e.g. 90° relative to one another.

The connecting portions 6 are formed integrally with the annular segments 5 and they consist of the same material as said annular segments. In the case of an alternative embodiment, it would be imaginable to provide a connecting means through which the respective connecting portions 6 are, preferably releasably, connected to an annular segment 5. In the case of such an embodiment, a respective annular segment 5 would be fixedly connected to a connecting portion 6 and it would be adapted to be coupled to a neighbouring annular segment 5 so that the stabilization means can be adapted modularly to the length of the corrugated portion of a corrugated hose.

In the following, the mode of operation of the present invention will be explained in detail.

The corrugated hose 2 is used a charge air hose in the field of automotive engineering. When said corrugated hose is used as a charge air hose, large amounts of air are conveyed therethrough into the internal combustion engine, e.g. a turbo-diesel engine. Since, due to the internal combustion engine, the air is conveyed in a pulsating mode, the hose is caused to vibrate. This will result in various vibrations. In particular, high-frequency vibrations will be generated, which will essentially impair the noise level of the vehicle. In addition, the engine compartments of today's vehicles are very limited in space, and the charge air hoses must often follow curvatures in space so as to connect the charge air cooler to the internal combustion engine. Other components of the internal combustion engine are located very close to the charge air hose. Due to the vibrations of the charge air hose, elongations in the longitudinal direction may occur, which will have the effect that the charge air hose comes into contact with other components, whereby it will be damaged. The stabilization means according to the present invention intends to prevent such damage. Both the radial and the axial strength of the charge air hose are increased by the stabilization means. Due to the knitted structure of the stabilization means, a very high flexibility is additionally obtained, which allows even strong curvatures in space, so that the charge air hose can be installed in the engine compartment even if the space available is very limited. Simultaneously, the knitted structure, which has good damping properties, is able to influence the vibration behaviour of the charge air hose in the desired way. Due to the additional stabilization, it is possible to substantially reduce the intake noise of the motor vehicle in the area of the charge air hose and to effectively counteract a radial expansion and an elongation in the axial direction

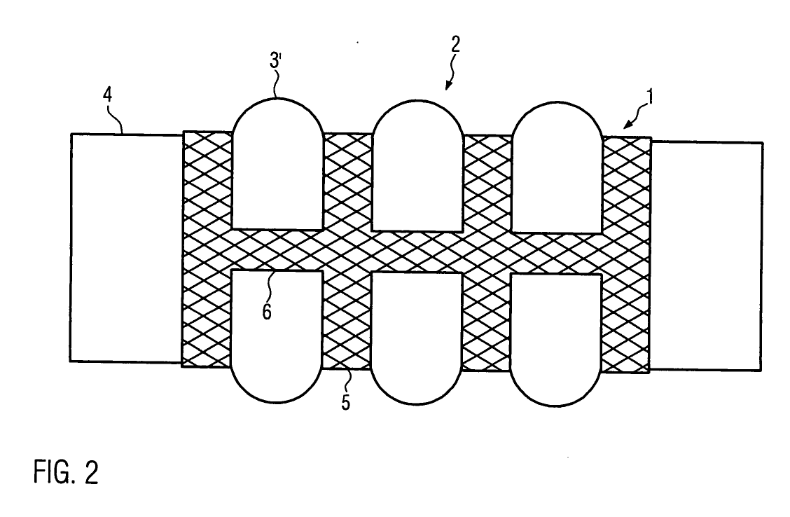

In FIG. 2, a second exemplary embodiment of the present invention is shown. In order to avoid repetitions, only the differences existing in comparison with the first embodiment will be discussed.

Other than the first embodiment, the corrugated hose 2 according to the second embodiment, which is connected to the stabilization means, has bulges 3′ instead of corrugations 3; these bulges have a substantially semicircular contour, the largest diameter of the bulges 3′ being larger than the cylindrical outer surfaces 4 of the corrugated hose adjacent to said bulges 3′. The bulges 3′ are followed on both sides thereof by corrugated hose portions having a substantially constant diameter, the diameter in said corrugated hose portion corresponding essentially to the diameter of the cylindrical outer surface 4 of the corrugated hose. The bulges may vary in shape. It is imaginable to configure them such that, in the representation according to FIG. 2, e.g. their outer diameter becomes larger from one bulge to the next from the left to the right. The outer peripheries of the bulges will then be located substantially within a conical surface. Likewise, the outer diameters of the bulges can decrease or increase from the outer bulges to the inner bulge.

The mode of operation of the second embodiment corresponds essentially to that of the first one, the modified contour of the corrugated hose providing advantages with regard to a very stable and precise positioning of the annular segments on the corrugated hose. A movement of the stabilization means in the longitudinal direction of the corrugated hose is thus effectively counteracted.

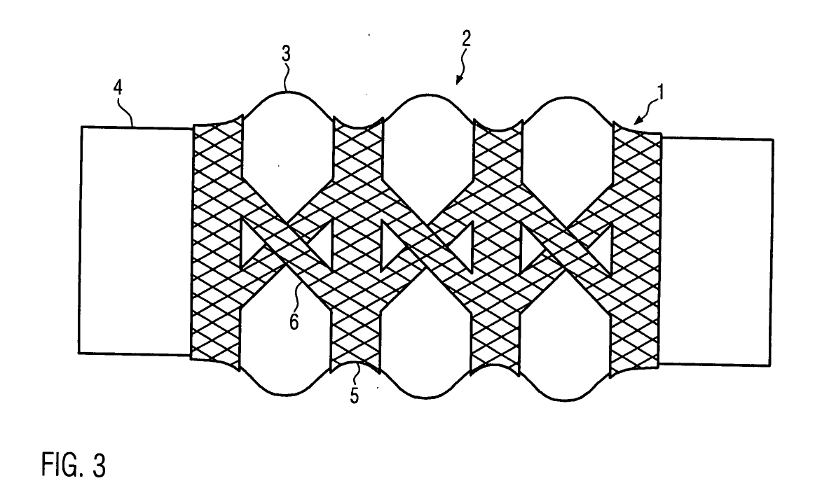

In FIG. 3 a third exemplary embodiment is shown. In order to avoid repetitions, only the differences existing in comparison with the first embodiment will be discussed.

Other than the first embodiment, this embodiment comprises connecting portions 6 which extend at an oblique angle to the longitudinal direction of the corrugated hose and which intersect one another. In the embodiment shown, four respective connecting portions 6 interconnect two neighbouring annular segments 5. Two respective connecting portions 6 are displaced by 180° in the circumferential direction (the connecting portions that are displaced by 180° relative to the depicted connecting portions cannot be seen in FIG. 3). Alternatively, also a plurality of intersecting connecting portions 6 may be distributed over the circumference.

In comparison with connecting portions extending in the longitudinal direction of the corrugated hose, intersecting connecting portions, which extend at an oblique angle to the longitudinal direction, primarily offer the advantage that the stability of the corrugated hose will be increased in the radial as well as in the axial direction, whereby the reinforcement can effectively be adapted through the overlapping angle. Moreover, the connecting portion arrangement described effectively prevents the annular segments from changing their position relative to one another, and in particular it prevents a rotational displacement in the circumferential direction.

In the following, the method according to the present invention, which is used for applying the described stabilization means to the outer surface of a corrugated hose, will be explained.

According to an exemplary method, the stabilization means can be applied to the outer surface of a corrugated hose by continuously knitting the stabilization means around the corrugated hose, preferably by means of an automatic circular knitting machine. In the case of an elastomeric corrugated hose, it may be of advantage that the stabilization means is knitted onto the still raw hose. In this condition, the hose has preferably not yet been provided with corrugations. In a subsequent step, the hose has formed or impressed thereon the wavelike contour; in the course of this process, the knitted-on stabilization means will adapt itself to the wave shape such that the annular segments will be arranged in the valleys and interconnected via the connecting portions which abut on the intermediate waves. Finally, the wavelike contour of the corrugated hose is fixed by vulcanization. It is also imaginable to use, instead of the knitting method described, a weaving or a braiding method.

In accordance with another exemplary method, the stabilization means is pulled over the corrugated hose. In the case of an elastomeric corrugated hose, this is done either after the pre-vulcanization or after the vulcanization. This guarantees the necessary manageability of the corrugated hose for pulling the stabilization means over the hose.

It be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. A stabilization means for a corrugated hose, comprising at least one corrugated portion with at least one corrugation which projects relative to the corrugated hose and which extends, at least in certain sections thereof, essentially in the circumferential direction of said corrugated hose, said stabilization means comprising at least one annular segment which, when mounted on said corrugated hose, surrounds the circumference of said corrugated hose adjacent the corrugation, wherein the annular segment is a substantially planar structure comprising individual threads or strands that are arranged relative to one another.

2. A stabilization means according to claim 1, wherein the annular segment has a knitted structure.

3. A stabilization means according to claim 1, wherein the annular segment has a woven or braided structure.

4. A stabilization means according to claim 1, wherein the threads or strands defining the annular segment consist of a natural material, preferably cotton or cellulose.

5. A stabilization means according to claim 1, wherein the threads or strands defining the annular segment consist of a polymer material, preferably of polyester, polyamide, polypropylene, polyethylene or aramid.

6. A stabilization means according to claim 1, wherein the threads or strands defining the annular segment consist of an inorganic, non-metallic material or of a metallic material.

7. A stabilization means according to claim 1, wherein the annular segment is positively connected to the corrugated hose.

8. A stabilization means according to claim 1, wherein the annular segment is connected to the corrugated hose by a substance-to-substance bond.

9. A stabilization means according to claim 1, wherein the annular segment is connected to the corrugated hose in such a way that it is under tension in the circumferential direction.

10. A stabilization means according to claim 1, wherein at least two annular segments are provided, wherein at least one of the corrugations is adapted to be arranged therebetween, at least one connecting means being provided, which extends between the annular segments such that it bridges the at least one of said corrugations and which interconnects the annular segments.

11. A stabilization means according to claim 1, wherein the connecting means is defined by a connecting portion which interconnects the two annular segments, said connecting portion being fixedly connected to at least one of said annular segments.

12. A stabilization means according to claim 1, wherein the connecting portion is adapted to be releasably connected to at least one of said annular segments.

13. A stabilization means according to claim 1, wherein the connecting portion consists of a natural material, preferably of cotton or cellulose.

14. A stabilization means according to claim 1, wherein the connecting portion consists of a polymer material, preferably of polyester, polyamide, polypropylene, polyethylene or aramid.

15. A stabilization means according to claim 1, wherein the connecting portion consists of an inorganic, non-metallic material or of a metallic material.

16. A stabilization means according to claim 1, wherein the connecting portion is integrally connected to at least one of said annular segments, the annular segment and the connecting portion consisting of the same material.

17. A stabilization means according to claim 1, wherein all the annular segments and connecting portions are integrally connected to one another, the annular segment and the connecting portion consisting of the same material.

18. A stabilization means according to claim 1, wherein the connecting portion abuts on the at least one corrugation at least in certain sections thereof.

19. A stabilization means according to claim 1, wherein the connecting portions interconnecting the annular segments are arranged along a line, preferably in the longitudinal direction of the corrugated portion.

20. A stabilization means according to claim 1, wherein the connecting portions are essentially tape-shaped.

21. A stabilization means according to claim 1, wherein the width of the connecting portions in the circumferential direction of the corrugated portion is substantially equal to or smaller than the distance between the two annular segments connected by the connecting portion.

22. A stabilization means according to claim 1, wherein the width of the connecting portions corresponds essentially to half the distance between the two annular segments connected by the connecting portion.

23. A stabilization means according to claim 1, wherein at least two spaced connecting portions are provided on the circumference of the annular segments.

24. A stabilization means according to claim 1, wherein the circumferentially spaced connecting portions are arranged on opposed sides of the annular segments.

25. A stabilization means according to claim 1, wherein three connecting portions, which are displaced by 120° relative to one another, are arranged in the circumferential direction of the annular segments.

26. A stabilization means according to claim 1, wherein four connecting portions, which are displaced by 90° relative to one another, are arranged in the circumferential direction of the annular segments.

27. A stabilization means according to claim 1, wherein connecting portions which define neighbouring connecting portions in the circumferential direction have different lengths.

28. A stabilization means according to claim 1, wherein two neighbouring annular segments define an angle so that the hose has a curvature.

29. A stabilization means according to claim 1, wherein the connecting portions extend at an oblique angle to the longitudinal direction of the hose.

30. A stabilization means according to claim 1, wherein the connecting portions intersect one another.

31. A corrugated hose comprising at least one corrugated portion with at least one corrugation which projects relative to the corrugated hose and which extends, at least in certain sections thereof, in the circumferential direction of said corrugated hose, and further comprising a stabilization means according to claim 1.

32. A corrugated hose comprising at least one corrugated portion with at least one bulge having a substantially semicircular contour, said bulge projecting relative to the corrugated hose and extending, at least in certain sections thereof, in the circumferential direction of said corrugated hose, and said bulge being followed on either side thereof by a corrugated hose portion having a substantially constant diameter, and further comprising a stabilization means according to claim 1.

33. A method for stabilizing a corrugated hose, comprising:
configuring a stabilization means with at least one corrugated portion with at least one corrugation which projects relative to the corrugated hose and which extends, at least in certain sections thereof, essentially in the circumferential direction of said corrugated hose, said stabilization means comprising at least one annular segment which, when mounted on said corrugated hose, surrounds the circumference of said corrugated hose adjacent the corrugation, wherein the annular segment is a substantially planar structure comprising individual threads or strands that are arranged relative to one another; and
applying the stabilization means to the outer surface of a corrugated hose.

34. A method according to claim 33, wherein the applying includes:
knitting the stabilization means continuously around the corrugated hose.

35. A method according to claim 33, comprising:
using automatic circular knitting machines for executing said continuous knitting.

36. A method according to claim 33, wherein the corrugated hose includes an elastomeric material, and the stabilization means is knitted onto the raw corrugated hose.

37. A method according to claim 33, comprising:
braiding or weaving the stabilization means continuously around the corrugated hose.

38. A method according to claim 33, comprising:
pulling the stabilization means over the corrugated hose.

39. A method according to claim 38, wherein the corrugated hose includes an elastomeric material, the stabilization means being pulled over the elastomeric corrugated hose in a pre-vulcanized or vulcanized condition.

40. A stabilization means according to claim 4, wherein the annular segment is positively connected to the corrugated hose.

41. A stabilization means according to claim 40, wherein at least two annular segments are provided, wherein at least one of the corrugations is adapted to be arranged therebetween, at least one connecting means being provided, which extends between the annular segments such that it bridges the at least one of said corrugations and which interconnects the annular segments.

42. A stabilization means according to claim 41, wherein all the annular segments and connecting portions are integrally connected to one another, the annular segment and the connecting portion consisting of the same material.

43. A stabilization means according to claim 42, wherein the width of the connecting portions in the circumferential direction of the corrugated portion is substantially equal to or smaller than the distance between the two annular segments connected by the connecting portion.

44. A stabilization means according to claim 43, wherein at least two spaced connecting portions are provided on the circumference of the annular segments.

45. A stabilization means according to claim 44, wherein connecting portions which define neighbouring connecting portions in the circumferential direction have different lengths.

46. A corrugated hose comprising at least one corrugated portion with at least one corrugation which projects relative to the corrugated hose and which extends, at least in certain sections thereof, in the circumferential direction of said corrugated hose, and further comprising a stabilization means according to claim 45.
